(19) United States
(12) Patent Application Publication
(10) Pub. No.: US 2003/0152072 A1
(43) Pub. Date: Aug. 14, 2003

(54) Routing device for all optical networks

(76) Inventors: Kenneth Guild, London (GB); Michael O'Mahony, Suffolk (GB); Anna Tzanakaki, Essex (GB); Dimitra Simeonidou, Essex (GB)

Correspondence Address: BUCKLEY, MASCHOFF, TALWALKAR, & ALLISON, 5 ELM STREET, NEW CANAAN, CT, 06840, US

(21) Appl. No.: 10/240,284

(22) PCT Filed: Mar. 28, 2001
(86) PCT No.: PCT/GB01/01370

(30) Foreign Application Priority Data
Mar. 28, 2000 (GB) 0007552.3

(51) Int. Cl. H04Q 11/00

(52) U.S. Cl. 370/386; 370/388

(57) ABSTRACT

An optical routing device for wavelength division multiplexed (WDM) optical signals includes an optical switch matrix (50) having a first optical switch array (54) and a second optical switch array (52), the first optical switch array being adapted to couple optical signals to the second optical switch array on the basis of the wavelength of respective optical signals. The second optical switch array (52) includes a number of optical switch devices, each of which is dedicated to route traffic on a respective wavelength. The device includes a drop traffic path and a through traffic path, in which the drop traffic path includes a transponder unit (170; 220) that is selectively reconfigurable to couple signals to a through traffic path and thereby provide a signal regeneration path. The transponder unit (170; 220) may be tunable so as to provide a wavelength translation function for any optical signal received by the transponder unit. This feature enables efficient sharing of transponders.

### BACKGROUND TO THE INVENTION

Current telecommunications networks running over dense wavelength division multiplexed (DWDM) fibre optic facilities, have yet to reach the full potential inherent in photonic transmission. This is because conventional equipment (SONET,SDH) require conversion of optical signals to electrical signals at various points on the network. These conversions introduce complexity, increase expense, and reduce bandwidth relative to what would be possible with an all-optical network.

A circuit-switched all-optical network offers many advantages overtodays opto-electronic networks, including greater throughput, better price/performance, platforms that offer a smaller physical footprint.

Optical networks were deployed initially with each fibre acting as a point-to-point link: all the data entering one end of a fibre was received at the other end. More advanced network designs have shifted the topology so that the fibre passes multiple possible traffic destinations. At each possible destination, the traffic must be routed correctly so that information is removed from the fibre or left on it, depending on its ultimate destination. Also, new traffic can be added as the fibre passes these intermediate destinations. Adding and dropping network traffic is supported by devices known as add/drop multiplexers. The SONET,SDH networks that dominate the telecommunications industry today require the signal to be converted from optical photons to electronic signals in order to perform these adds and drops. This process adds complexity and cost and slows down the movement of data through the network.

Cross-connects operate at junctions in the carrier's backbone network to route traffic to its proper destination, with potentially hundreds of individual circuits intersecting at the switch. A switching matrix is used to direct incoming data streams to the appropriate output port. This is one of the most challenging elements in an all-optical network, and today's solutions are still electronic, requiring an optical-electronic-optical (OEO) conversion sequence. Early versions of optical cross-connects have been produced that offer switch fabrics with 16-port-by-16-port capacity. What is needed and will emerge over the next several years are switch matrices with 128-by-128 capacity and greater, together with the ability to switch individual wavelengths (lambdas) within a given fibre to another wavelength in any other fibres. Most optical cross-connect systems on the market today are actually opto-electronic solutions that convert the signal to the electrical domain and switch it using an electronic matrix.

An all-optical network would overcome unnecessary expensive opto-electronic conversions in telecommunications networks. By removing the relatively slower electronics elements of the system, the benefits of photonics (speed, reliability, low cost, and freedom from electromagnetic interference) can be more fully realised.

More recently, optical networks and DWDM have began to offer advantages beyond simply greater bandwidth. Network designers now are considering ways to enhance the functionality and bandwidth utilisation of optical networks using packet-over-fibre technology that leverages DWDM in particular.

### SUMMARY OF THE INVENTION

According to a first aspect of the present invention, an optical routing device for wavelength division multiplexed (WDM) optical signals comprises an optical input stage, an optical output stage, and an optical routing stage for coupling optical signals to the optical output stage, wherein the optical routing stage includes a first optical switch array and a second optical switch array, the first optical switch array being adapted to selectively couple optical signals to the second optical switch array on the basis of the wavelength of the respective optical signal.

Preferably, the first optical switch array comprises a number of 2×2 optical switches.

Preferably, the optical input stage comprises a number of optical demultiplexers that couple individual wavelengths to respective optical switches within the first optical switch array.

Preferably, the second optical switch array comprises a number of optical switch devices, each of which is dedicated to route traffic on a respective wavelength.

Preferably, the second optical switch array comprises a number K of N×N optical switch devices, each of which is dedicated to route traffic on a respective wavelength, where K is the number of different wavelengths supported by the optical routing device and N is the number of fibre pairs supported by the optical routing device.

Preferably, the optical routing stage comprises a plurality of optical wavelength planes over which the first optical switch array and the second optical switch array are distributed. More preferably, each optical wavelength plane is adapted to route N×M wavelengths, where N is the number of fibre pairs supported by the optical routing device and M is a whole number.

Preferably, the optical routing device comprises a drop traffic path and a through traffic path, wherein the drop traffic path includes a transponder unit that is selectively reconfigurable to couple optical signals to a through traffic path, thereby to provide a signal regeneration path. More preferably, the optical routing device comprises an add traffic path that is coupled to the through traffic path via a transponder unit. Most preferably, a drop traffic path is selectively connectable to an add traffic path via a transponder unit to provide a signal regeneration path.

Preferably, the optical routing device comprises a fibre select unit coupled to the optical input stage for selecting traffic to be coupled to a drop traffic path.

Preferably, the optical routing device further comprises a drop select unit coupled to the fibre select unit for selecting one or more individual wavelengths that are to be dropped.

Preferably, the fibre select unit comprises an N×N optical switch for connecting a fibre select unit to a drop select unit, where N is the number of fibre pairs supported by the optical routing device.

Preferably, the drop select unit is coupled to a transponder unit, the transponder unit being adapted to regenerate optical signals before onward transmission.

Preferably, the optical routing device comprises an add select unit for coupling add traffic signals to the first switch array. Preferably, the add select unit is operatively connected to a drop traffic path via a transponder unit.

Preferably, the transponder unit is tunable so as to provide a wavelength translation function for any optical signal received by the transponder unit. This feature enables efficient sharing of transponders.

Preferably, the transponder unit comprises a first optical interface having an optical receiver and an optical transmitter, a second optical interface having an optical receiver and an optical transmitter, and a control means for routing signals between the first optical interface and the second optical interface, and between the optical transmitter and the optical receiver within at least one of the first and second optical interfaces.

Preferably, the optical routing device is an optical cross-connect for use in a WDM communications system.

According to a second aspect of the present invention, an optical routing device for wavelength division multiplexed (WDM) optical signals comprises an optical switch matrix having a first optical switch array and a second optical switch array, the first optical switch array being adapted to couple optical signals to the second optical switch array on the basis of the wavelength of respective optical signals, wherein the second optical switch array comprises a number of optical switch devices, each of which is dedicated to route traffic on a respective wavelength.

According to a third aspect of the present invention, an optical add/drop multiplexer (OADM) device for wavelength division multiplexed (WDM) optical signals includes a drop traffic path and a through traffic path, wherein the drop traffic path comprises a transponder unit that is selectively reconfigurable to couple optical signals to the through traffic path, thereby to provide a signal regeneration path for optical signals.

According to a fourth aspect of the present invention, a transponder unit comprises a first optical interface having an optical transmitter and an optical receiver, a second optical interface having an optical transmitter and an optical receiver, and a control device for routing signals between the first optical interface and the second optical interface, and between the optical transmitter and the optical receiver within at least one of the first and second optical interfaces.

Preferably, the transponder unit is tunable so as to provide wavelength translation on one or more signal paths.

In the present invention, the switch fabric for an optical cross-connect is separated into a first optical switch array, preferably consisting of a number of 2×2 switches, and a second optical switch array consisting of a number of switches, each of which is dedicated to route traffic on a respective wavelength. This arrangement reduces by half the size of the largest switch element in the switch fabric. The device includes an add traffic path coupled to the first optical switch array. An add traffic path may be coupled to a drop traffic path via a transponder unit that provides a signal regeneration path for those signals that need “cleaning-up” before onward transmission as through traffic. The transponder unit may be tuneable so as to provide wavelength translation for add traffic, irrespective of whether the traffic originates from a local client or traffic that is dropped via a signal regeneration path for onward transmission as through traffic.

### BRIEF DESCRIPTION OF THE DRAWINGS

Examples of the present invention will now be described in detail with reference to the accompanying drawings, in which:

FIG. 1 is a simplified schematic diagram of an optical routing node in accordance with the present invention;

FIG. 2 is a simplified diagram of the architecture of an example of an optical routing node;

FIG. 3 is a more detailed example of the architecture of an optical routing node;

FIG. 4 is a simplified diagram of an example of the architecture of a switch matrix within an optical wavelength plane;

FIG. 5 illustrates a single fibre pair path through an example of an optical wavelength plane;

FIG. 6 is a simplified schematic diagram of an example of a transponder unit in accordance with the present invention;

FIG. 7 illustrates the operating modes of the transponder of FIG. 6;

FIG. 8 illustrates another simplified example of the architecture of an optical routing node; and,

FIG. 9 illustrates yet another simplified example of the architecture of an optical routing node.

### DETAILED DESCRIPTION

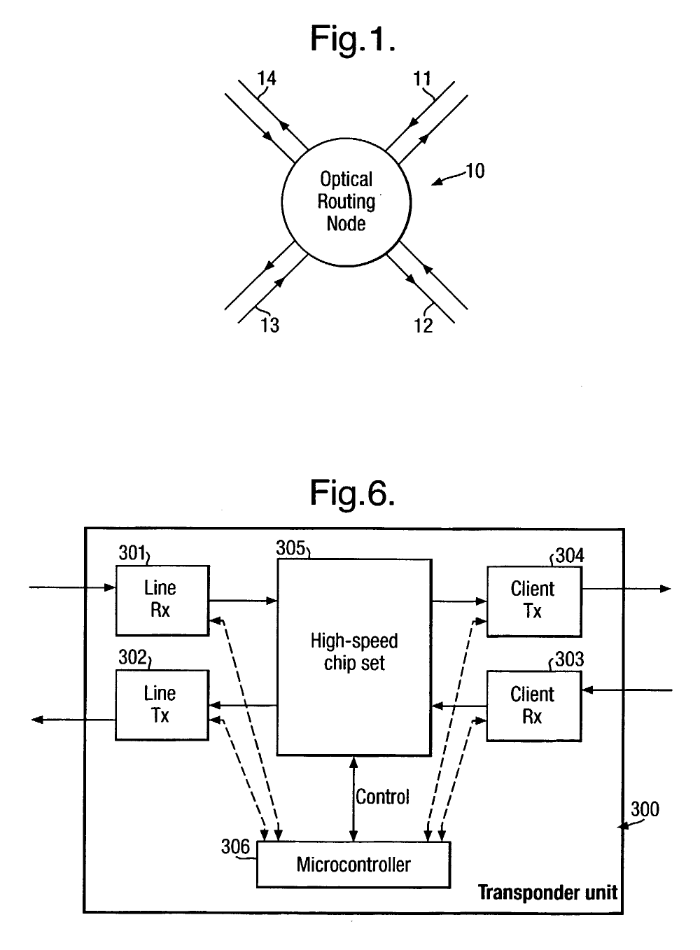

FIG. 1 is a simplified schematic diagram of an optical routing node 10 in accordance with the present invention. The design requirement for the optical node 10 is to transparently route signals optically from fibre to fibre. In this example, only 4 fibre pairs 11 to 14 are shown. As will be described in detail below, the optical node 10 is able to route any traffic on any wavelength within any fibre to any other fibre on any wavelength; this is referred to as an optical-cross connect (OXC) function. In addition, dynamic reconfiguration of network topologies is becoming increasingly attractive and the ability to provision transparent wavelength services or optically interconnect to optical sub-networks (MANs/WANs) is also a requirement. The “adding” and “dropping” of wavelengths is termed the optical add/drop multiplexing (OADM) function of the optical node 10. The optical node 10 is able to drop up to 100% traffic to a local client. A client is defined as the end-user after the signal has been dropped from the core of the network; this hand-off point will be referred to as the network edge.

As will be described in detail below, in some cases an optical signal may need to be regenerated or “cleaned-up” and so the optical node 10 allows the flexibility to selectively regenerate any wavelength on any fibre. In order to establish virtual wavelength paths across a network, wavelength translation may be necessary at the optical node 10. As will be described in detail below, the flexible manner in which wavelengths can be selected for wavelength translation via a regeneration unit significantly reduces the blocking probability within an optical network. Rather than pre-allocating a regenerator for a particular wavelength on a particular fibre, the optical node 10 is able to share regenerators, thus offering significant cost savings to the customer. This function will become increasingly important as more mesh-like network architectures evolve from today's ring-based networks and provide more flexibility to the network management in path revisioning.

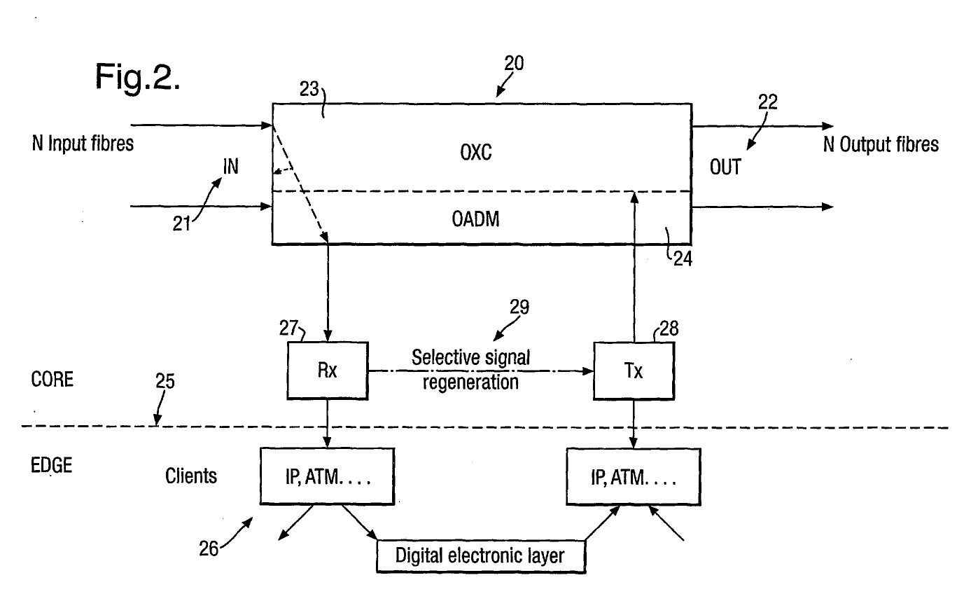

FIG. 2 shows a simplified diagram of the architecture of an example of an optical routing node 20. Traffic arriving at the N input fibres 21 can be routed to N output fibres 22: this is referred to as an optical cross connect (OXC) function 23. Furthermore, the optical node incorporates an optical add/drop multiplexing (OADM) function 24 that provides flexible traffic management at an interface 25 with local clients 26. The OADM 24 enables a variety of protocols to be transported across a network in a transparent manner.

In operation, some traffic arriving at the input fibres 21 of the optical node 20 will traverse the optical node 20 through the OXC 23 without being dropped to local clients 26. This is termed “through traffic”. The remainder is directed through the OADM 24 as “drop traffic”. Traffic that originates from a local client 26 is termed “add traffic”, and is routed through the OADM 24 to the output fibres of the OXC.

A number of optical transponders 27,28 are provided at the interface 25 of the OADM 24 of the optical node 20. These transponders may either be fixed wavelength or tunable, depending on requirements. The transponders 27,28 provide a gateway between the core network (not shown) and the clients 26 requiring access to it. They ensure that the data rates, data format, power levels and wavelengths of the client signals are groomed appropriately for transport through the network. This is achieved through optical-electrical-optical (OEO) conversion.

In some cases an optical signal may need to be “cleaned-up” and so the optical node 10 incorporates a transponder arrangement that provides a regeneration path 29 to selectively regenerate any wavelength on any fibre. Using tuneable transponders, wavelength translation can also be provided as and when necessary. Rather than pre-allocating a regeneration path for a particular wavelength on a particular fibre, the optical node is able to share regenerators. This will be described in detail below.

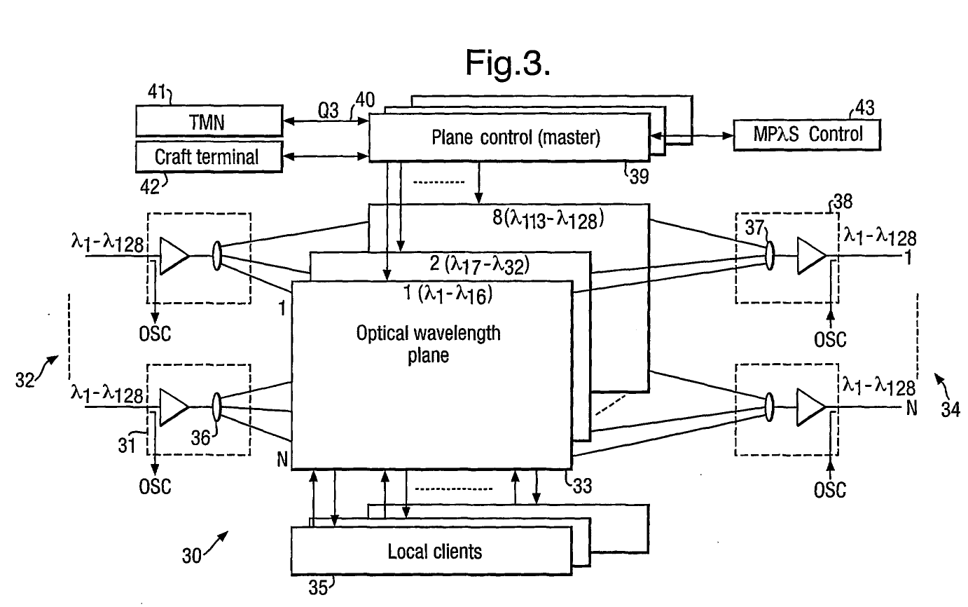

A more detailed example of the architecture of an optical routing node 30 is shown in FIG. 3. As shown in FIG. 3, line interface units (LIUS) 31 at the optical input fibres 32 extract the optical supervisory channel (OSC) and provide broadband amplification. The OSC channel contains information relating to the network. The primary use of the OSC is to detect a fibre break, which is indicated by the loss of this signal.

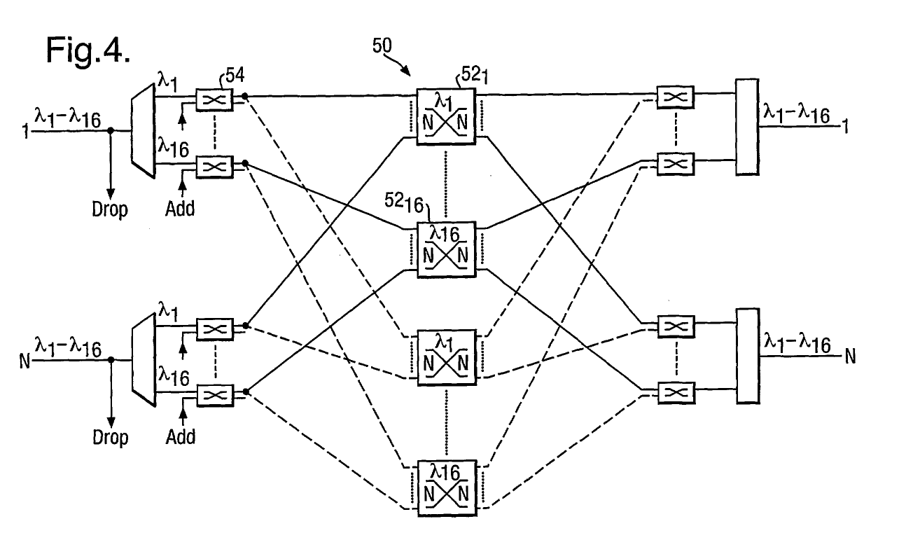

Optical couplers 36 broadcast the wavelengths to the appropriate optical wavelength planes 33. Each optical wavelength plane 33 is designed to route N times 16 wavelengths, where N is the number of fibre pairs. As will be discussed below, N is also the size of a single optical switching element within a switch fabric (see FIG. 4). The entire optical node 30 is designed to allow the value of N to be increased, thereby up-grading the capabilities of the optical node. Clearly, the value of N will vary depending on the size of the system being installed. For the purpose of this example, N is equal to 4. Each optical wavelength plane 33 is designed for 16 channels; these are based on the ITU 100 Ghz spacings.

The optical wavelength plane 33 is able to cross-connect channels through a switch fabric to the desired output fibre 34 or add/drop channels from/to local clients 35. Optical couplers 37 within LIUs 38 recombine the signals from the other wavelength planes, whereupon they are amplified and returned to the optical line section at the output fibres 34.

A plane controller 39 manages each optical wavelength plane 33. A single plane controller 39 is designated as the master and communicates via a Q3 interface 40 to 9 remote network management system 41. Local control of the optical node is available via a graphical user interface (GUI) on a craft terminal 42. A distributed management solution may be offered via an MPAS control plane 43.

A simplified diagram of an example of the architecture of the switch matrix within an optical wavelength plane 50 is shown in FIG. 4. This illustrates the interconnection of the 16 N×N switch elements 52, termed switch matrix units (SMUs), and the 1:1 protection strategy adopted for this switch fabric (indicated by the dashed lines). As shown, add-traffic is routed across an SMU 52 via a 2×2 switch 54.

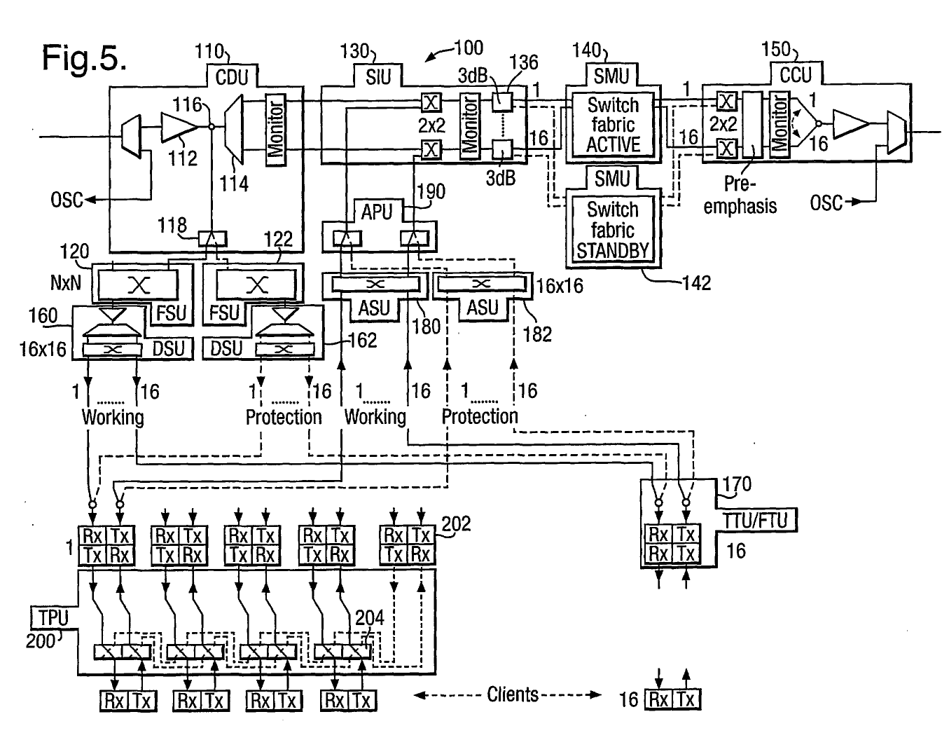

FIG. 5 illustrates a single fibre pair path through an example of an optical wavelength plane 100.

In this example, a channel distribution unit 110 (CDU) uses an erbium-doped fibre amplifier (EDFA) 112 to overcome some of the loss within the optical node. The channels are fed to a demultiplexer 114 and 5% of the signal power is extracted to monitor the power of each of the 16 wavelengths. Prior to demultiplexing the signals, an asymmetric splitter 116 directs 80% of the input through a high reliability switch 118 to working or protection fibre selection units (FSU) 120 and 122, respectively.

Typically, 70-80% of traffic will traverse the optical node without being dropped, as opposed to the 20-30% of drop traffic that is directed to local clients. The demultiplexed wavelengths from the CDU 110 are input to a switch interface unit (SIU) 130 together with wavelengths that originate from local clients (add traffic). The 2×2 switches 132 within the SIU 130 direct the appropriate traffic into power monitors 134 to ensure signal integrity. Like-wavelengths from each SIU 130 are grouped together and incident to a respective switch matrix unit (SMU) 140. An optical splitter 136 allows the same signals to enter a protection SMU 142 such that in the event of the failure of a working SMU 140, the associated protection SMU 142 can be rapidly switched into service by a channel conditioning unit (CCU) 150. In addition to selecting the working of protection SMU 142, the CCU 150 performs signal level power adjustments and optical signal monitoring prior to combining and amplifying the multiplex.

The process for dropping traffic is as follows:

the FSU 120 allows the client (or group of clients) to select from which fibre it wishes to extract a wavelength. A drop select unit (DSU) 160 amplifies the multiplex using an EDFA and demultiplexes the comb into its individual wavelengths, whereupon a 16×16 switch element 162 allows the appropriate wavelength to be connected to the corresponding transponder 170 associated with the client. As shown, the FSU 120 and DSU 170 are duplicated (122 and 162, respectively) for protection purposes. The signal is received by the transponder 170 and is translated to a short-haul wavelength of 1310 nm. The optical channel transport overhead information is extracted and processed before handing-off to the local client.

The transponder 170 is available in two varieties: fixed and tunable transponder units (FTU and TTU). When adding traffic to the optical transport network, the local client traffic is re-timed and encapsulated using a digital wrapper format prior to inserting it into the optical transport network on the desired wavelength. As the name implies, an FTU is only able to add traffic on a predetermined wavelength whereas a TTU is able to address any wavelength. An add select unit (ASU) 180 enables various input ports of the SIU 130 to be addressed to reduce the probability of blocking. An add protection unit (APU) 190 selects the traffic from a protection ASU 182 in the event of a switch failure within the working ASU 180.

A transponder protection unit (TPU) 200 is provided to offer protection against the failure of a transponder. A 1:4 protection scheme is shown here, although this may be changed depending on the customer preferences. Essentially, a fifth transponder 202 is used as a standby for the other four. In the event of a transponder failure, the appropriate switch 204 is set within the TPU 200 and traffic being serviced by the faulty unit is redirected to the protection transponder 203. Since the protection transponder 202 should be able to address multiple wavelengths, it must be the tunable type and will have to be aware of the wavelengths of the transponders it is protecting such that rapid switch-over is achieved.

FIG. 6 shows an example of a tunable transponder unit (TTU) 300, suitable for use in the architecture of FIG. 5. This unit provides an interface to the client network at the edge of the optical transport network via a TPU (not shown) and likewise, an interface between the optical transport network via an ASU (not shown). It is configured to insert and extract channel overhead information and pass this to the PCU (not shown) for processing. It is also adapted to detect and manage local status alarms.

The transponder unit 300 can be broadly divided into six functional blocks. These are a line receiver 301, which carries out optical-to-electrical (OE) conversion, a line transmitter 302, which carries out electrical-to-optical (EO) conversion, and a similar client receiver 303 and client transmitter 304 pair, together with a high-speed electronic chip set 305 and micro-controller circuitry 306.

The high-speed electronic chip set links the data paths from all four OE/EO interfaces 301-304 and allows read/write access to certain portions of the frames of data passing through the transponder unit 300. It also allows flexible connectivity between the four interfaces 301-304. This is achieved by electrical switching within integrated circuits forming the high-speed electronic chip set 305. The output from either receiver 301,303 may be directed to either one or both of the transmitter inputs.

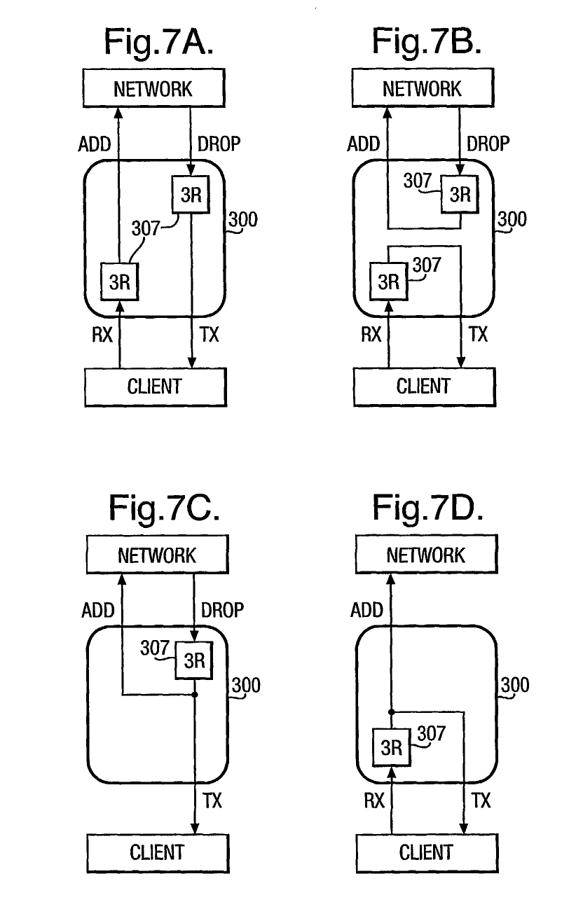

This results in the four combinations shown in FIGS. 7A-7D, which are referred to as the operating modes of the transponder unit.

As indicated, the transponder unit 300 provides a signal regeneration (3R) function 307. The operating modes include a simple add/drop mode (FIG. 7A), a regeneration/loop-back mode (FIG. 7B), a regeneration/drop mode (FIG. 7C), and an add/loop-back mode (FIG. 7D). The transponder unit 300 may also be tunable and therefore provide a wavelength translation function.

The operating modes of the transponder unit 300 are set by the micro-controller 306, which passes the appropriate commands to the high-speed electronic chip set 305 in order to set up the routing between the interfaces. It does this in response to instructions from the network management which are passed to it via the PCU (not shown).

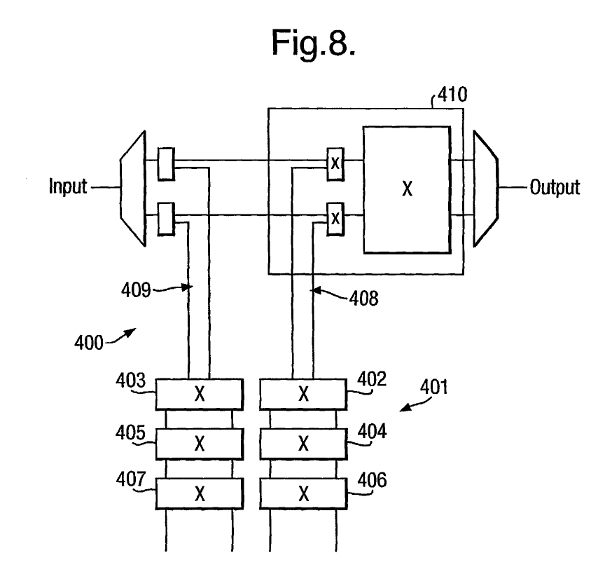

FIG. 8 shows an extension of the OXC architecture described above. The OXC 400 shown in FIG. 8 includes a Clos network 401 (Clos, C., (1953), “A study of non-blocking switching networks”, Bell Syst. Tech. Jour., 32,406-24) including primary 402, 403, secondary 404, 405 and tertiary 406, 407 switching stages used in the add and drop paths 408,409, respectively. This architecture provides full interconnectivity between all the incoming channels that can potentially be dropped locally and the transponders (not shown) that are associated with clients. In other words, any dropped wavelength channel originating from any input fibre can be directed to any transponder. In addition, the architecture provides full connectivity between the added wavelength channels originating from clients and the input ports of the SIU 410, thus enabling routing of any channel that is added locally to any available SIU.

The Clos network 401 enables more efficient sharing and utilisation between transponders that are used for regeneration and/or wavelength conversion because the transponders do not need to be grouped into sets that are accessible by a limited number of wavelength channels associated with a particular DSU (not shown). Instead, any transponder is accessible to any dropped wavelength channel and also any added wavelength channel originating from any transponder can be directed to any available input port of an SIU 410.

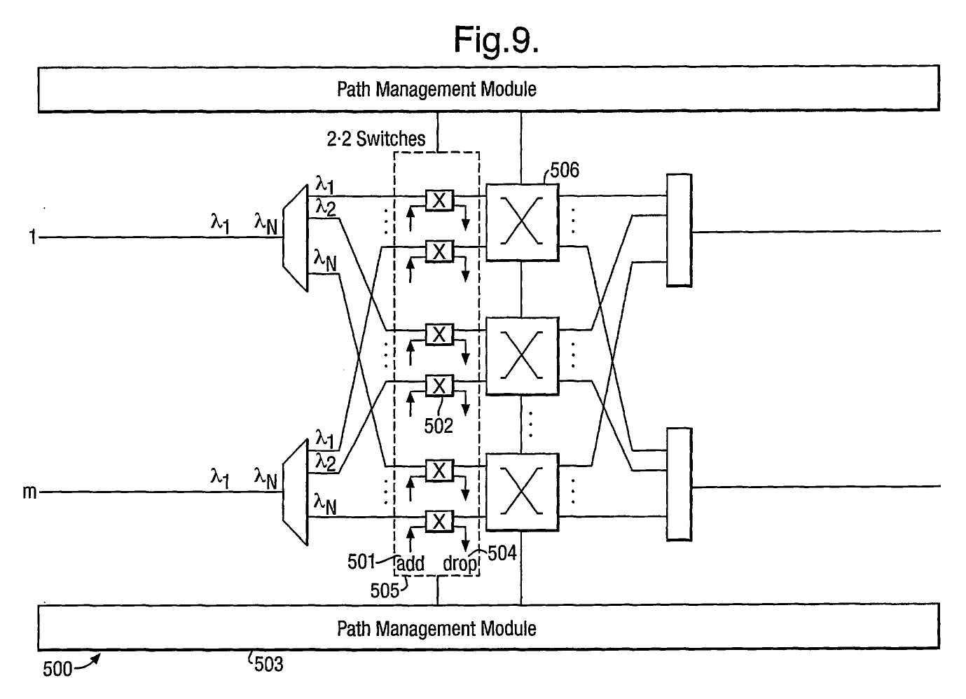

FIG. 9 shows another example of an optical cross-connect architecture 500. A first optical switch array 501 is provided consisting of a number of 2×2 optical switches 502 for directing add, drop and through traffic under the control of a path management module 503. Although not shown, each drop path 504 is connected to a transponder unit similar to that described above that facilitates signal regeneration for onward transmission either to a local client or to an add path 505 coupled to a 2×2 optical switch 502 within the optical switch array 501.

It is possible to construct a simple OADM architecture by dispensing with the second optical switch array 506 within the switch matrix shown in FIG. 9.

1. An optical routing device for wavelength division multiplexed (WDM) optical signals, comprising an optical input stage, an optical output stage, and an optical routing stage for coupling optical signals to the optical output stage, wherein the optical routing stage includes a first optical switch array and a second optical switch array, the first optical switch array being adapted to selectively couple optical signals to the second optical switch array on the basis of the wavelength of the respective optical signal.

2. An optical routing device according to claim 1, in which the first optical switch array comprises a number of 2×2 optical switches.

3. An optical routing device according to claim 1 or 2, in which the optical input stage comprises a number of optical demultiplexers that couple individual wavelengths to respective optical switches within the first optical switch array.

4. An optical routing device according to any preceding claim, in which the second optical switch array comprises a number of optical switch devices, each of which is dedicated to route traffic on a respective wavelength.

5. An optical routing device according to any preceding claim, in which the second optical switch array comprises a number K of N×N optical switch devices, each of which is dedicated to route traffic on a respective wavelength, where K is the number of different wavelengths supported by the optical routing device and N is the number of fibre pairs supported by the optical routing device.

6. An optical routing device according to any preceding claim, in which the optical routing stage comprises a plurality of wavelength planes over which the first optical switch array and the second optical switch array are distributed.

7. An optical routing device according to claim 6, in which each optical wavelength plane is adapted to route N×M wavelengths, where N is the number of fibre pairs supported by the optical routing device and M is a whole number.

8. An optical routing device according to any preceding claim, comprising a drop traffic path and a through traffic path, wherein the drop traffic path includes a transponder unit that is selectively reconfigurable to couple optical signals to a through traffic path thereby to provide a signal regeneration path.

9. An optical routing device according to claim 8, in which a transponder unit is tuneable so as to provide a wavelength translation function for any optical signal received by the transponder unit.

10. An optical routing device according to claim 8 or 9, further comprising an add traffic path that is coupled to the through traffic path via a transponder unit.

11. An optical routing device according to any of claims 8 to 10, in which a drop traffic path is selectively connectable to an add traffic path via a transponder unit to provide a signal regeneration path.

12. An optical routing device according to any preceding claim, comprising a fibre select unit coupled to the optical input stage for selecting traffic to be coupled to a drop path.

13. An optical routing device according to claim 12, comprising a drop select unit coupled to the fibre select unit for selecting one or more individual wavelengths that are to be dropped.

14. An optical routing device according to claim 13, in which the fibre select unit comprises an N×N optical switch for connecting a fibre select unit to a drop select unit, where N is the number of fibre pairs supported by the optical routing device.

15. An optical routing device according to claim 13 or 14, in which the drop select unit is coupled to a transponder unit, the transponder unit being adapted to regenerate optical signals before onward transmission.

16. An optical routing device according to any of claims 13 to 15, further comprising an add select unit for coupling add traffic signals to the first switch array.

17. An optical routing device according to claim 16, in which the add select unit is operatively connected to a drop traffic path via a transponder unit.

18. An optical routing device according to claim 17, in which the transponder unit comprises a first optical interface having an optical receiver and an optical transmitter, a second optical interface having an optical receiver and an optical transmitter, and a control means for routing signals between the first optical interface and the second optical interface, and between the optical transmitter and the optical receiver within at least one of the first and second optical interfaces.

19. An optical cross-connect for use in a wavelength division multiplexed (WDM) communications system, comprising an optical routing device according to any preceding claim.

20. An optical routing device for wavelength division multiplexed (WDM) optical signals, comprising an optical switch matrix having a first optical switch array and a second optical switch array, the first optical switch array being adapted to couple optical signals to the second optical switch array on the basis of the wavelength of respective optical signals, wherein the second optical switch array comprises a number of optical switch devices, each of which is dedicated to route traffic on a respective wavelength.

21. An optical routing device according to claim 20, in which the size of optical switch in the first optical switch array is less than the size of optical switch in the second optical switch array.

22. An optical add/drop multiplexer (OADM) device for wavelength division multiplexed (WDM) optical signals, comprises a drop traffic path and a through traffic path, wherein the drop traffic path comprises a transponder unit that is selectively reconfigurable to couple optical signals to the through traffic path, thereby to provide a signal regeneration path for optical signals.

23. A transponder unit comprising a first optical interface having an optical receiver and an optical transmitter, a second optical interface having an optical receiver and an optical transmitter, and a control device for routing signals between the first optical interface and the second optical interface, and between the optical transmitter and the optical receiver within at least one of the first and second optical interfaces.

24. A transponder unit according to claim 21, in which the transponder unit is tunable so as to provide wavelength translation on one or more signal paths.
